(19) United States
(12) Patent Application Publication
(10) Pub. No.: US 2013/0142226 A1
(43) Pub. Date: Jun. 6, 2013

(54) SIGNAL TRANSMISSION SYSTEM, SIGNAL TRANSMISSION METHOD AND COMMUNICATION DEVICE

(71) Applicant: ALAXALA Networks Corporation, Kanagawa (JP)

(72) Inventors: Toru Sasaki, Yokohama (JP); Junji Baba, Hadano (JP); Naohisa Koie, Tokyo (JP)

(73) Assignee: ALAXALA NETWORKS CORPORATION, Kanagawa (JP)

(21) Appl. No.: 13/648,614

(22) Filed: Oct. 10, 2012

(30) Foreign Application Priority Data
Dec. 1, 2011 (JP) 2011-263286

(51) Int. Cl. H04B 1/38

(52) U.S. Cl. 375/219

(57) ABSTRACT

A signal transmission system comprises: a first circuit; a second circuit; a transmission line configured to transmit data from the first circuit to the second circuit by using a differential signal; a monitor configured to monitor an interval of transmission of the data; and a compensator configured to correct a transmission loss of the differential signal in the interval monitored by the monitor.

### CROSS-REFERENCE TO RELATED APPLICATION

The present application claims the priority based on Japanese Patent Application No. 2011-263286 filed on Dec. 1, 2011, the disclosure of which is hereby incorporated by reference in its entirety.

### BACKGROUND

1. Technical Field

The present invention relates to signal transmission technology.

2. Related Art

With an increase in traffic of data on the Internet, one communication device generally used is provided with an LSI (large scale integration) employing the serializer-deserializer system (hereinafter referred to as SerDes system) that enables high-speed data transmission. The SerDes system makes conversion between parallel data and serial data to allow high-speed data forwarding. Employing the SerDes system enables high-speed transmission of several tens Gbps (giga bit per second) level. During high-speed transmission, however, there is a loss of a differential signal (transmission loss) due to the high frequency loss on the transmission line.

One example of the technology proposed to correct such a transmission loss is the technique described in JP 2008-022392A. This technique transmits a signal of a specified pattern at the start-up of a communication device and corrects the offset of a differential signal to minimize the transmission loss, so as to optimize various parameters affecting the transmission loss of the sender circuit (hereinafter simply referred to as parameters).

The technique described in JP 2011-41109A specifies and stores in advance a relationship between the operating frequency and the parameters for a communication device to minimize the transmission loss. Even when there is an environmental change during operation of the communication device, this technique uses the optimum parameters corresponding to the operating frequency, so as to correct the transmission loss.

The technique described in JP 2008-022392A, however, cannot adequately deal with a variation in correction amount of the transmission loss accompanied with an environmental change, such as installation temperature and voltage fluctuation, during operation of the communication device. Additionally, it is rather troublesome and inconvenient to specify in advance the relationship between the operating frequency and the optimum parameters for each communication device as described in JP 2011-41109A. These problems are not characteristic of the communication device but may be commonly found in the system for data transmission.

In the system for data transmission of, for example, a communication device, there is accordingly a need for correcting the transmission loss without interfering with data transmission during operation of the system.

### SUMMARY

According to one aspect of the invention, there is provided a signal transmission system. The signal transmission system includes: a first circuit; a second circuit; a transmission line configured to transmit data from the first circuit to the second circuit by using a differential signal; a monitor configured to monitor an interval of transmission of the data; and a compensator configured to correct a transmission loss of the differential signal in the interval monitored by the monitor.

The invention is not limited to the configuration of the signal transmission system but may be configured as a signal transmission method or a communication device.

### BRIEF DESCRIPTION OF THE DRAWINGS

FIG. 1 is a block diagram illustrating the general configuration of a signal transmission system according to one embodiment of the invention;

FIG. 2 illustrates the configuration of a forwarding engine, a routing engine and a control unit;

FIG. 3 is a flowchart showing a procedure of optimization process;

FIG. 4 illustrates one example of a fixed pattern generated by a fixed pattern generator;

FIG. 5 illustrates one example of the fixed pattern received by a fixed pattern receiver; and

FIG. 6 illustrates another example of the fixed pattern received by the fixed pattern receiver.

### DETAILED DESCRIPTION

### A. Configuration of Signal Transmission System

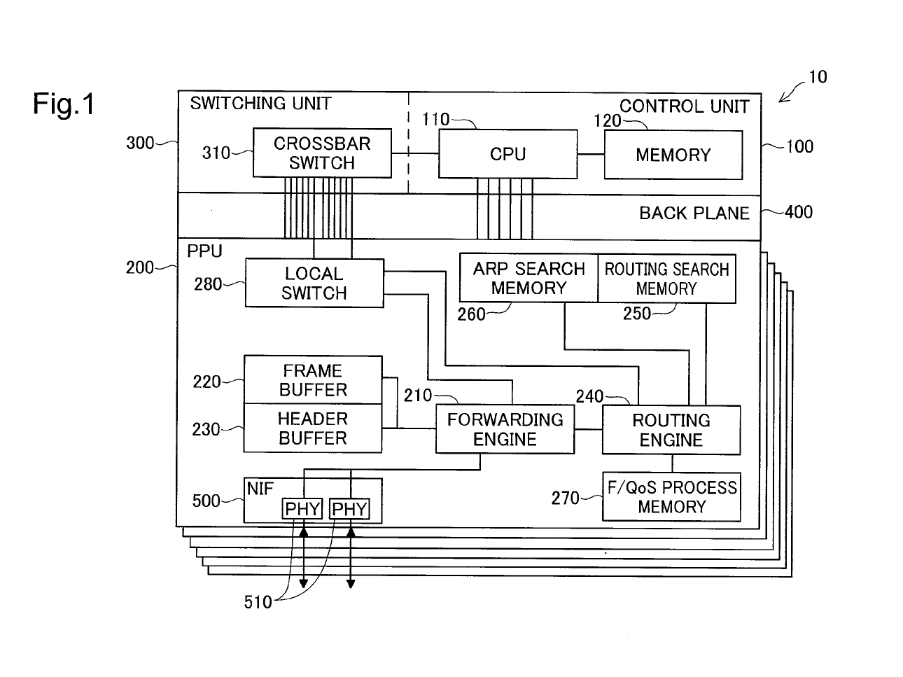

FIG. 1 is a block diagram illustrating the general configuration of a signal transmission system according to one embodiment of the invention. A communication device 10 provided as the signal transmission system includes a control unit 100, packet processor units 200 (hereinafter referred to as PPUs 200) and a switching unit 300, which are connected with one another in a back plane 400.

The control unit 100 works to control the entire communication device 10. The control unit 100 includes a CPU 110 and a memory 120. The control unit 100 is connected with the respective PPUs 200 via a crossbar switch 310 to control the respective PPUs 200.

The switching unit 300 is provided as a module for packet switching operations. The switching unit 300 includes the crossbar switch 310. The crossbar switch 310 is structured as an LSI (large scale integration) for high-speed switching of data transmission during packet forwarding among the PPUs 200, in response to an instruction from the control unit 100. According to this embodiment, six PPUs 200 are connected with the crossbar switch 310, and one network interface 500 (hereinafter referred to as NIF 500) is connected with each PPU 200.

The PPU 200 is provided as a module to control input and output of packets. The PPU 200 includes a forwarding engine 210 and a routing engine 240 individually structured as LSIs, and a local switch 280 connected with the crossbar switch 310. The forwarding engine 210 is connected with a frame buffer 220 and a header buffer 230. The routing engine 240 is connected with a routing search memory 250, an ARP (address resolution protocol) search memory 260 and a frame/QoS (Quality of Service) process memory 270. The correlation of destination network to net mask and gateway is stored in the routing search memory 250. The correlation of IP address to MAC address and physical port 510 is stored in the ARP search memory 260. Pieces of information on frame filtering, frame discarding and frame processing conditions such as the priority of processing are stored in the frame/QoS process memory 270. The routing search memory 250, the ARP search memory 260 and the frame/QoS process memory 270 may be configured, for example, as special memories called CAM (content-address memories) or by DRAMs.

The forwarding engine 210 receives a frame via the physical port 510 and temporarily stores data information included in the received frame into the frame buffer 220 and header information of the received frame into the header buffer 230. The forwarding engine 210 also sends the header information to the routing engine 240, in order to obtain information on MAC address and interface (PPU 200 and physical port 510) required for frame transmission. The forwarding engine 210 specifies an interface to be used for outputting the received frame, based on the search result sent back from the routing engine 240, and forwards the received frame to the crossbar switch 310 of the switching unit 300 via the local switch 280. The forwarding engine 210 corresponds to the “first circuit” of the invention.

The routing engine 240 receives the header information from the forwarding engine 210, extracts a destination IP address from the received header information, refers to the routing search memory 250 to determine a gateway of the forwarding destination of the frame, and refers to the ARP search memory 260 to determine an interface to be used for outputting the frame. The routing engine 240 also refers to the frame/QoS process memory 270 to obtain the pieces of information on frame filtering, frame discarding and frame processing conditions such as the priority of processing. The routing engine 240 transmits these obtained pieces of information to the forwarding engine 210. The routing engine 240 corresponds to the “second circuit” of the invention.

The NIF 500 is provided as a module to physically connect a network line, such as 1000BASE-T or 10 GBASE-T, with the communication device 10. The NIF 500 has the physical ports 510 used to connect the forwarding engine 210 with such a network line.

### B. Configuration of Forwarding Engine, Routing Engine and Control Unit

B-1. General Configuration

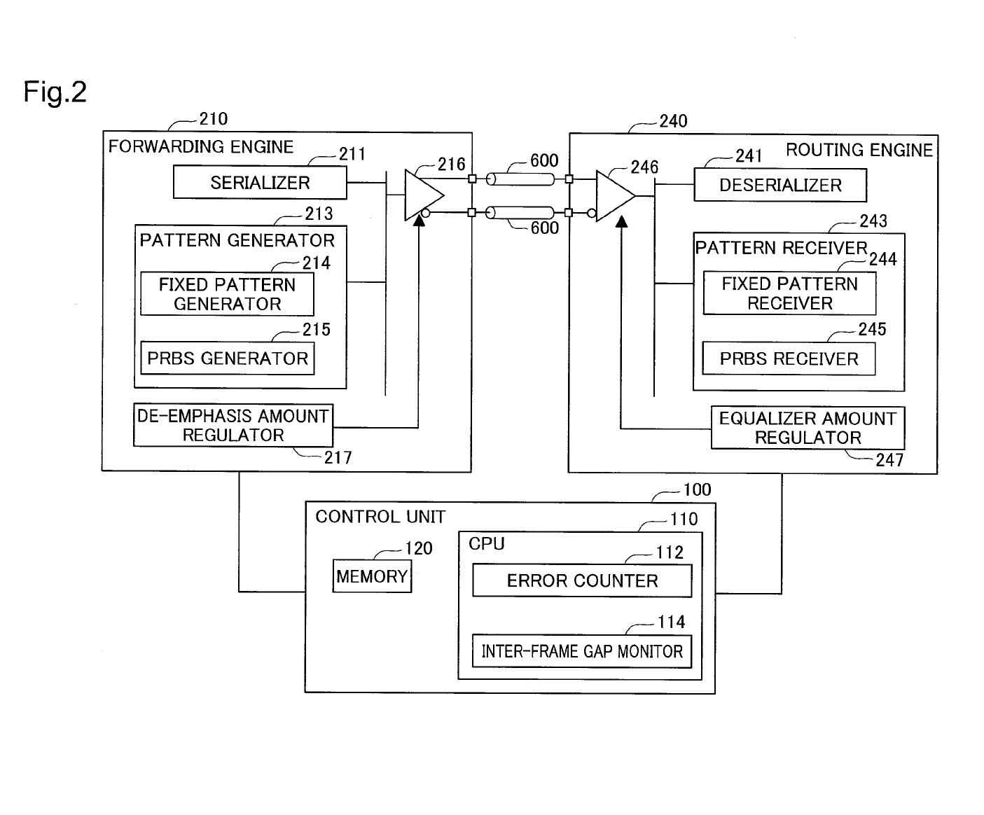

FIG. 2 illustrates the configuration of the forwarding engine 210, the routing engine 240 and the control unit 100. The forwarding engine 210 and the routing engine 240 are connected with each other by a differential transmission line 600. According to this embodiment, the SerDes (Serializer-Deserializer) system is employed for data transmission between the forwarding engine 210 and the routing engine 240.

The forwarding engine 210 and the routing engine 240 are respectively connected with the control unit 100. The CPU 110 of the control unit 100 serves as an error counter 112 and an inter-frame gap monitor 114. The error counter 112 corresponds to the “detector” of the invention, and the inter-frame gap monitor 114 corresponds to the “monitor” of the invention.

The error counter 112 counts errors occurring during transmission of data and transmission of a PRBS (pseudo random bit sequence) pattern or a fixed pattern (described later) between the forwarding engine 210 and the routing engine 240. The error counter 112 also calculates a BER (bit error rate), based on the counted errors. The PRBS pattern and the fixed pattern correspond to the “correction data stream” of the invention. More specifically, the fixed pattern and the PRBS pattern respectively correspond to the “first correction data stream” and the “second correction data stream”. The BER represents a rate of error in signal reception on the signal-receiving side to signals sent from the forwarding engine 210 and may be used as an indication of transmission loss in the differential transmission line 600. The BER increases depending on the change in external environment, such as temperature and voltage. The errors obtained as the calculation basis of the BER may be detected by the known parity check method or the CRC (cyclic redundancy check) method. The “transmission loss” includes loss, distortion and deviation of differential signals that occur during data transmission.

The inter-frame gap monitor 114 monitors whether data is sent and received between the forwarding engine 210 and the routing engine 240, and thereby determines whether the state of data transmission is currently in an inter-frame gap.

B-2. Configuration of Forwarding Engine

The forwarding engine 210 includes a serializer 211, a pattern generator 213, a de-emphasis amount regulator 217 and an output buffer 216.

The serializer 211 is provided as a circuit to convert low-speed parallel data to high-speed serial data. The serialized data is output from the output buffer 216.

The pattern generator 213 includes a fixed pattern generator 214 and a PRBS generator 215. The fixed pattern generator 214 is provided as a circuit to generate a fixed pattern during an optimization process described later. The PRBS generator 215 is provided as a circuit to generate a PRBS (pseudo random bit sequence) pattern during the optimization process. In the description hereof, the “optimization process” means a series of processing to optimize parameters (de-emphasis amount and equalizer amount) of the communication device 10, in order to reduce the transmission loss between the forwarding engine 210 and the routing engine 240. The pattern generator 213 corresponds to the “generator” of the invention.

The de-emphasis amount regulator 217 regulates the de-emphasis amount of a differential signal, in response to an instruction from the CPU 110. The operation of “regulating the de-emphasis amount” means changing the output voltage of the output buffer 216 based on the high frequency component attenuating in the differential transmission line 600, so as to adjust the elimination degree of the low frequency component. The differential signal is corrected by regulating the de-emphasis amount. The de-emphasis amount regulator 217 and an equalizer amount regulator 247 (described below) correspond to the “compensator” of the invention.

B-3. Configuration of Routing Engine

The routing engine 240 includes a deserializer 241, a pattern receiver 243, an equalizer amount regulator 247 and an input buffer 246.

The deserializer 241 restores the high-speed serial data output from the output buffer 216 and received by the input buffer 246 via the differential transmission line 600 into the original parallel data.

The pattern receiver 243 includes a fixed pattern receiver 244 and a PRBS receiver 245. In the optimization process described later, the fixed pattern receiver 244 receives a fixed pattern, and the PRBS receiver 245 receives a PRBS pattern. The pattern receiver 243 corresponds to the “receiver” of the invention.

The equalizer amount regulator 247 regulates the equalizer amount of the differential signal input into the input buffer 246, in response to an instruction from the CPU 110. The operation of “regulating the equalizer amount” means adjusting the amplification degree of the high frequency component in the input buffer 246, in order to restore the high frequency component attenuating in the differential transmission line 600. The differential signal is corrected by regulating the equalizer amount.

Although not being specifically illustrated, the communication device 10 has a channel of sending the differential signal from the routing engine 240 to the forwarding engine 210, as well as a channel of sending the differential signal from the forwarding engine 210 to the routing engine 240. The optimization process described below is performed separately in these two channels. There may be multiple sets of these two channels between the forwarding engine 210 and the routing engine 240.

### C. Optimization Process

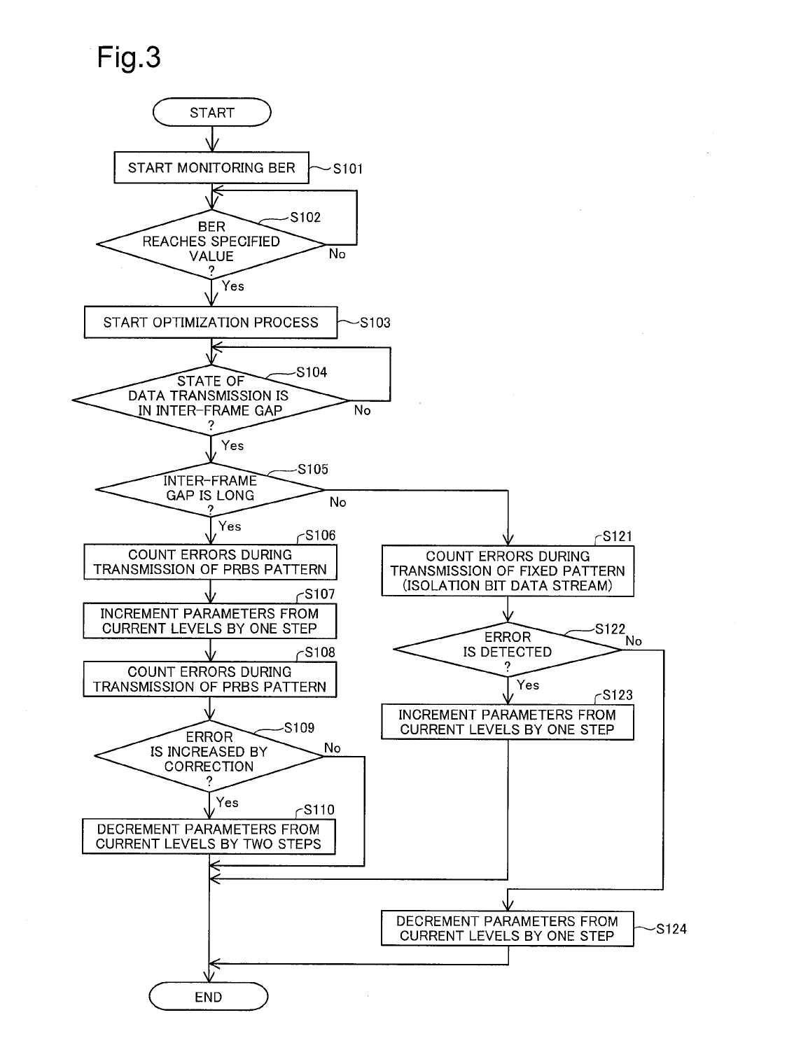

FIG. 3 is a flowchart showing a procedure of optimization process for the differential transmission line 600 between the forwarding engine 210 and the routing engine 240.

On the start-up of the communication device 10, the error counter 112 of the CPU 110 starts monitoring the BER (step S101).

The CPU 110 subsequently determined whether the BER calculated by the error counter 112 reaches or exceeds a specified value stored in advance in the memory 120 (step S102). When the BER does not yet reach the specified value (step S102: No), signal transmission continues between the forwarding engine 210 and the routing engine 240. The specified value may be set in advance according to the desired transmission quality of the communication device 10.

When the BER reaches or exceeds the specified value (step S102: Yes), on the other hand, the CPU 110 starts the optimization process (step S103) to optimize the de-emphasis amount and the equalizer amount, in order to change the correction amount of transmission loss (i.e., to reduce the transmission loss).

On the start of the optimization process, the inter-frame gap monitor 114 of the CPU 110 determines whether the state of data transmission between the forwarding engine 210 and the routing engine 240 is currently in the inter-frame gap (step S104).

The inter-frame gap means an interval between two consecutive frames that are to be treated by the forwarding engine 210. It is determined that the state of data transmission is currently in the inter-frame gap in the case of reception of an FCS (frame check sequence) of a previous frame. When it is determined that the state of data transmission is not currently in the inter-frame gap (step S104: No), the inter-frame gap monitor 114 continues monitoring.

When it is determined that the state of data transmission is currently in the inter-frame gap (step S104: Yes), on the other hand, the inter-frame gap monitor 114 subsequently determines whether the inter-frame gap is long (step S105). Data information included in a frame received via the physical port 510 is temporarily stored in the frame buffer 220. When no data information is stored in the frame buffer 220, there is no data transmission in the differential transmission line 600. In this case, the inter-frame gap monitor 114 determines that the inter-frame gap is long (step S105: Yes). When data information is stored in the frame buffer 220, on the other hand, the inter-frame gap monitor 114 determines that the inter-frame gap is short (step S105: No). According to this embodiment, the minimum value of the inter-frame gap is “12 bytes”. The “long inter-frame gap” means that the inter-frame gap is longer than 12 bytes and the “short inter-frame gap” means that the inter-frame gap is equal to 12 bytes.

When the inter-frame gap monitor 114 determines that the inter-frame gap is short (step S105: No), the CPU 110 directs the fixed pattern generator 214 to generate a fixed pattern, while directing the fixed pattern receiver 244 to receive the fixed pattern. The error counter 112 counts the errors occurring during transmission of the fixed pattern (step S121).

The fixed pattern is provided as a data stream of a specific length that is entirely receivable in the shortest inter-frame gap. The minimum value of the inter-frame gap is 12 bytes or 96 bits as mentioned above. This minimum value is defined by IEEE802.3 standard as a minimum interval for transmission of consecutive frames. The fixed pattern is an isolation bit data stream having only one bit in the data stream different from the other bits. The fixed pattern applicable in this embodiment may be, for example, “000 . . . 010 . . . 000” including an isolation bit “1” or “111 . . . 101 . . . 111” including an isolation bit “0”. The isolation bit is more susceptible to the changes of correction amounts in the output buffer 216 and the input buffer 246 accompanied with an environmental change, compared with successive bits such as “00” or “11”. This facilitates error detection by the error counter 112.

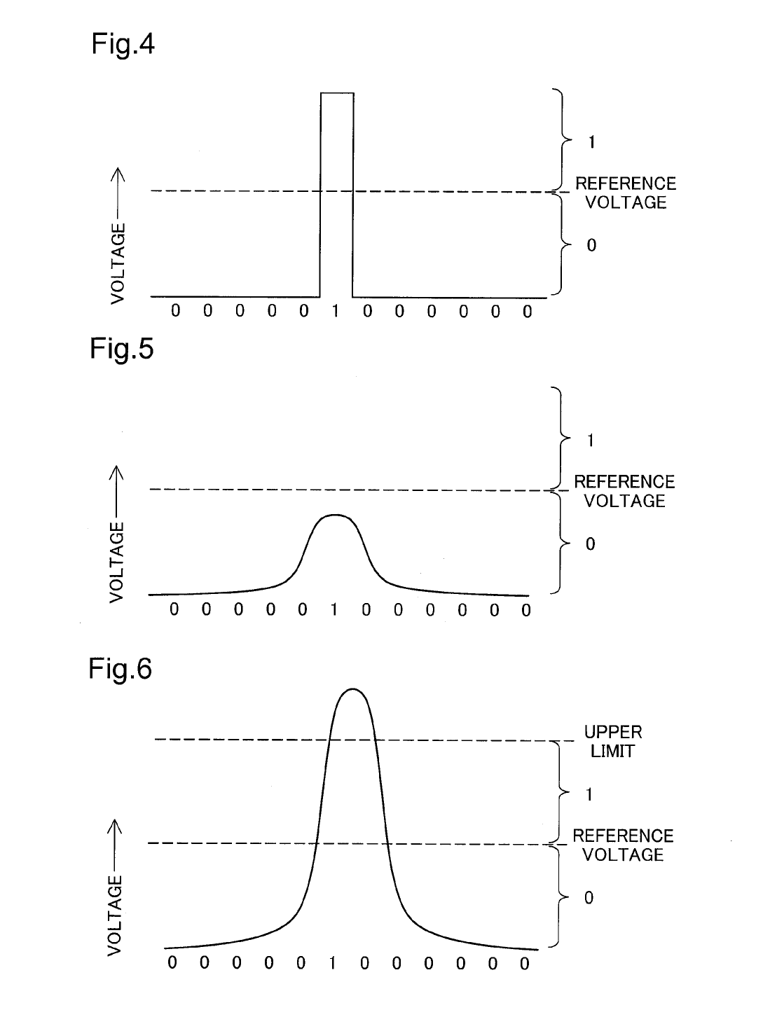

FIG. 4 illustrates one example of the fixed pattern generated by the fixed pattern generator 214. The broken line in the drawing represents the reference voltage. The signal value is set to “1” for the higher voltage than the reference voltage and is set to “0” for the lower voltage than the reference voltage. The fixed pattern generated by the fixed pattern generator 214 may have a waveform as shown in FIG. 4. The fixed pattern shown in FIG. 4 has the isolation bit “1”.

FIG. 5 illustrates one example of the fixed pattern received by the fixed pattern receiver 244. Attenuation of the high frequency component in the differential transmission line 600 changes the sharp peak at the isolation bit “1” shown in FIG. 4 to a lower, gentler peak. This changes the signal value set to “1” at the isolation bit “1” in the fixed pattern of FIG. 4 to the signal value “0”. This means erroneous signal transmission. An error is accordingly detected by the error counter 112.

When an error is detected by the error counter 112 (step S122: Yes), the de-emphasis amount regulator 217 and the equalizer amount regulator 247 respectively increment the de-emphasis amount and the equalizer amount from the respective current levels by one step, in response to an instruction of the CPU 110 (step S123). Incrementing by one step is attributed to the fact that the temperature in the installation environment of the communication device 10 is not likely to have an abrupt decrease but is likely to rise during the operation of the communication device 10. This temperature rise leads to attenuation of the high frequency component as shown in FIG. 5. The de-emphasis amount and the equalizer amount to be changed by one step may be set arbitrarily, for example, in the initialization phase.

FIG. 6 illustrates another example of the fixed pattern received by the fixed pattern receiver 244. When no error is detected during transmission of the fixed pattern (step S122: No) irrespective of the BER that reaches or exceeds the specified value (step S102: Yes), it is assumed that the isolation bit of the fixed pattern shown in FIG. 4 is excessively emphasized and changed to a waveform as shown in FIG. 6, which causes a noise signal. In this case, the de-emphasis amount regulator 217 and the equalizer amount regulator 247 respectively decrement the de-emphasis amount and the equalizer amount from the respective current levels by one step (step S124).

The regulation of the de-emphasis amount and the equalizer amount at step S123 or at step S124 is performed when the inter-frame gap monitor 114 determines that the state of data transmission is currently in the inter-frame gap. Regulating the de-emphasis amount and the equalizer amount during ordinary data transmission may disturb the waveform of the differential signal and cause a frame defect.

When the inter-frame gap monitor 114 determines that the inter-frame gap is long (step S105: Yes), on the other hand, the CPU 110 directs the PRBS generator 215 to generate a PRBS pattern, while directing the PRBS receiver 245 to receive the PRBS pattern. The error counter 112 counts errors occurring during transmission of the PRBS pattern (step S106).

According to this embodiment, the PRBS pattern may be a pseudo random bit sequence of about 1000 bit-size. Transmission of the PRBS pattern requires a significantly longer inter-frame gap, compared with transmission of the fixed pattern of 96-bit size. The communication rate of the communication device 10 is, however, the gigabit unit per second. The time required for transmission of the bit sequence of 1000-bit size is significantly shorter than the time required for storing the successively received frames into the frame buffer 220. The PRBS pattern can thus be successfully transmitted within the inter-frame gap.

After counting the errors during transmission of the PRBS pattern, the CPU 110 directs the de-emphasis amount regulator 217 and the equalizer amount regulator 247 to respectively increment the de-emphasis amount and the equalizer amount from the respective current levels by one step toward the emphasizing direction (step S107).

After incrementing the de-emphasis amount and the equalizer amount by one step, the CPU 110 directs the PRBS generator 215 and the PRBS receiver 245 to generate and receive a PRBS pattern and counts errors occurring during transmission of the PRBS pattern (step S108) in the same manner as step S106 described above. The error counter 112 can thus obtain the count of errors before the increment at step S107 and the count of errors after the increment at step S107.

The error counter 112 compares the counts of errors before and after the increment and determines whether the number of errors is increased by the increment (step S109). When the number of errors is decreased by the increment (step S109: No), this means that the increment at step S107 corrects the differential signal and thereby reduces the transmission loss. The CPU 110 then terminates the optimization process.

When the number of errors is increased by the increment (step S109: Yes), on the other hand, this means that incrementing the de-emphasis amount and the equalizer amount by one step toward the emphasizing direction increases the transmission loss. It is thus expected that decrementing the de-emphasis amount and the equalizer amount by one step instead of incrementing at step S107 will correct the differential signal and reduce the transmission loss. The CPU 110 accordingly directs the de-emphasis amount regulator 217 and the equalizer amount regulator 247 to respectively decrement the de-emphasis amount and the equalizer amount from the respective current levels by two steps (step S110). This is equivalent to decrementing the de-emphasis amount and the equalizer amount by one step from the levels of the de-emphasis amount and the equalizer amount at step S106. This corrects the differential signal and reduces the transmission loss. The CPU 110 then terminates the optimization process.

Even after termination of the optimization process using the fixed pattern and the PRBS pattern, monitoring the BER continues during operation of the communication device 10. The above series of optimization process is repeated when the BER reaches or exceeds the specified value again.

As described above, the communication device 10 provided as one embodiment of the signal transmission system regulates the de-emphasis amount and the equalizer amount in the inter-frame gap to correct the differential signal without interfering with data transmission. The fixed pattern and the PRBS pattern may be selectively used for error detection according to the length of the inter-frame gap. For the short inter-frame gap, the error detection employs the fixed pattern including the isolation bit, which can be transmitted within the minimum inter-frame gap. Even in the short inter-frame gap, this configuration enables accurate error detection and adequate regulation of the de-emphasis amount and the equalizer amount to correct the differential signal. For the long inter-frame gap, on the other hand, the error detection employs a longer data stream such as the PRBS pattern, in order to enable detection of errors that are undetectable by the fixed pattern. This configuration enables regulation of the de-emphasis amount and the equalizer amount with higher accuracy to correct the differential signal. The de-emphasis amount and the equalizer amount are regulated stepwise toward the direction of reducing the transmission loss in the inter-frame gap, so as to gradually approach to the respective optimum values during operation of the communication device 10. The de-emphasis amount and the equalizer amount can thus be regulated with high accuracy toward the direction of reducing the transmission loss. The communication device 10 provided as one embodiment of the signal transmission system can reduce the transmission loss without interfering with frame forwarding by taking into account the manufactured properties of the communication device and the environmental change during operation of the communication device.

### D. Modifications

The foregoing describes one embodiment of the invention. The invention is, however, not limited to the above embodiment but various modifications and variations may be made to the embodiment without departing from the scope of the invention. For example, the functions implemented by the software configuration may be implemented by the hardware configuration. The following describes some examples of possible modifications.

According to the above embodiment, the optimization process starts when the BER reaches or exceeds the specified value at step S101. According to another embodiment, the optimization process may start, for example, on the start-up of the communication device 10, independently of the BER reaching or exceeding the specified value. According to yet another embodiment, after the start-up of the communication device 10, the procedure may count the number of errors during transmission a data stream of the longer length than the length of the PRBS pattern used in the above embodiment, regulate the de-emphasis amount and the equalizer amount, and start data transmission. The optimization process described in the above embodiment may be performed after the start of data transmission.

The optimization process regulates both the de-emphasis amount and the equalizer amount according to the above embodiment but may regulate only either one of the de-emphasis amount and the equalizer amount according to another embodiment. The de-emphasis amount may be replaced with a pre-emphasis amount.

In the optimization process of the above embodiment, the error detection employs the PRBS pattern for the long inter-frame gap. Any data stream that enables error detection, for example, a fixed data stream, may be used instead of the PRBS pattern, for error detection.

According to the above embodiment, either the fixed pattern or the PRBS pattern is used for error detection in the inter-frame gap. Using the fixed pattern or the PRBS pattern is, however, not essential. According to another embodiment, when the BER reaches or exceeds the specified value, the de-emphasis amount and the equalizer amount may be regulated directly in the inter-frame gap to correct the differential signal.

The above embodiment describes the optimization process for data transmission from the forwarding engine 210 to the routing engine 240. The optimization process is, however, not limited to the data transmission between the forwarding engine 210 and the routing engine 240 but is also applicable to data transmission between any circuits that enable high-speed data transmission.

### E. Other Aspects

The signal transmission system of the above aspect of the invention corrects the differential signal without interfering with data transmission during operation of the system. According to one embodiment, the signal transmission system of the above aspect may further include a detector configured to detect a degree of transmission loss of the data, wherein the compensator may perform correction according to the degree of transmission loss detected by the detector. The signal transmission system of this embodiment corrects the differential signal according to the degree of transmission loss, thereby correcting (reducing) the transmission loss.

According to another embodiment of the signal transmission system of the above aspect, the first circuit may include a generator configured to generate a differential signal representing a specified correction data stream in the interval. The second circuit may include a receiver configured to receive the differential signal representing the specified correction data stream. The compensator may perform the correction in the interval, based on a degree of transmission loss of the correction data stream detected by the detector. The signal transmission system of this embodiment corrects the differential signal based on the transmission loss of the correction data stream, thus correcting (reducing) the transmission loss with higher accuracy.

According to yet another embodiment of the signal transmission system of the above aspect, when a specified interval is monitored by the monitor, the generator may generate a differential signal representing a first correction data stream that is entirely receivable in the specified interval. When a longer interval than the specified interval is monitored by the monitor, the generator may generate a differential signal representing a second correction data stream that is longer than the first correction data stream. The signal transmission system of this embodiment can selectively use the first correction data stream and the second correction data stream that is longer than the first correction data stream, according to the length of the interval. Even for the short interval, this configuration enables detection of the transmission loss without interfering with data transmission and correction of the differential signal. For the longer interval, this configuration enables detection of the transmission loss with higher accuracy and adequate correction (reduction) of the transmission loss.

According to still another embodiment of the signal transmission system of the above aspect, the first correction data stream transmitted in the interval may include a plurality of identical bits and one different bit. In the signal transmission system of this embodiment, the correction data stream includes one different bit. This facilitates detection of the transmission loss and enables correction (reduction) of the transmission loss with high accuracy.

According to still another embodiment of the signal transmission system of the above aspect, the compensator may perform the correction when the detector detects a higher bit error rate than a specified bit error rate during transmission of data in the transmission line. The signal transmission system of this embodiment corrects the differential signal when the bit error rate reaches or exceeds the specified bit error rate. This enables correction to make the quality of signal transmission by the signal transmission system approach a desired quality level.

According to yet another embodiment of the signal transmission system of the above aspect, the first circuit may receive a frame and transmit information relating to search of data required for forwarding the frame to the second circuit. The second circuit may search the data required for forwarding the frame based on the information and send back the searched data to the first circuit. The signal transmission system of this embodiment enables frame forwarding, while correcting (reducing) the transmission loss.

According to still another embodiment of the signal transmission system of the above aspect, the interval may be an inter-frame gap. The signal transmission system of this embodiment enables correction of the differential signal without affecting the frame.

What is claimed is:

1. A signal transmission system, comprising:
a first circuit;
a second circuit;
a transmission line configured to transmit data from the first circuit to the second circuit by using a differential signal;
a monitor configured to monitor an interval of transmission of the data; and
a compensator configured to correct a transmission loss of the differential signal in the interval monitored by the monitor.

2. The signal transmission system according to claim 1, further comprising:
a detector configured to detect a degree of transmission loss of the data, wherein
the compensator performs correction according to the degree of transmission loss detected by the detector.

3. The signal transmission system according to claim 2, wherein
the first circuit includes a generator configured to generate a differential signal representing a specified correction data stream in the interval,
the second circuit includes a receiver configured to receive the differential signal representing the specified correction data stream, and
the compensator performs the correction in the interval, based on a degree of transmission loss of the correction data stream detected by the detector.

4. The signal transmission system according to claim 3, wherein
when a specified interval is monitored by the monitor, the generator generates a differential signal representing a first correction data stream that is entirely receivable in the specified interval, and
when a longer interval than the specified interval is monitored by the monitor, the generator generates a differential signal representing a second correction data stream that is longer than the first correction data stream.

5. The signal transmission system according to claim 4, wherein
the first correction data stream transmitted in the interval includes a plurality of identical bits and one different bit.

6. The signal transmission system according to claim 2, wherein
the compensator performs the correction when the detector detects a higher bit error rate than a specified bit error rate during transmission of data in the transmission line.

7. The signal transmission system according to claim 1, wherein
the first circuit receives a frame and transmits information relating to search of data required for forwarding the frame to the second circuit, and
the second circuit searches the data required for forwarding the frame based on the information and sends back the searched data to the first circuit.

8. The signal transmission system according to claim 1, wherein
the interval is an inter-frame gap.

9. A signal transmission method, comprising the steps of
transmitting a differential signal from a first circuit to a second circuit across a transmission line;
monitoring an interval of transmission of the differential signal; and
correcting a transmission loss of the differential signal in the monitored interval.

10. A communication device comprising:
a transferring unit that includes a network interface to be coupled to a network; and
a control unit coupled to the transferring unit;
wherein the transferring unit further includes a forwarding engine that stores header information of a frame received via the network interface, a routing engine that specifies an interface to be used for outputting the received frame, based on the header information, and a transmission line that couples the forwarding engine and the routing engine; and
wherein the control unit includes a monitor that monitors data transmission from the forwarding engine to the routing engine by using a differential signal, and a compensator that corrects a transmission loss of the differential signal when an interval of data transmission is monitored by the monitor.
